(19) United States
(12) Patent Application Publication
(10) Pub. No.: US 2007/0091028 A1
(43) Pub. Date: Apr. 26, 2007

(54) Plasma display apparatus

(75) Inventors: Tae Heon Kim, Seoul (KR); Dongki Paik, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/583,815

(22) Filed: Oct. 20, 2006

(30) Foreign Application Priority Data
Oct. 21, 2005 (KR) 10-2005-0099908

(51) Int. Cl. G09G 3/28

(52) U.S. Cl. 345/68

(57) ABSTRACT

A plasma display apparatus is disclosed. The plasma display apparatus includes a plasma display panel including an electrode, a voltage controller, a scan operating unit, and a driving signal supply unit. The voltage controller includes a switch unit for forming a set-down pulse gradually falling to a first voltage for a first duration of time of a set-down period and for forming the first voltage for a second duration of time of an address period. The scan operating unit forms a second voltage during the address period. The driving signal supply unit supplies the set-down pulse to the electrode during the set-down period, and supplies the first voltage and the second voltage to the electrode during the address period.

This Nonprovisional application claims priority under 35 U.S.C. § 119(a) on Patent Application No. 10-2005-0099908 filed in Korea on Oct. 21, 2005 the entire contents of which are hereby incorporated by reference.

### BACKGROUND

1. Field

This document relates to a plasma display apparatus.

2. Description of the Related Art

A plasma display apparatus comprises a plasma display panel in which a discharge cell is filled with a main discharge gas and an inert gas, and a driver. When a high frequency voltage is supplied to an electrode of the plasma display panel, the inert gas generates vacuum ultraviolet rays, which thereby cause a phosphor formed between barrier ribs of the plasma display panel to emit light.

The plasma display apparatus displays an image during each of subfields constituting a frame. Each of the subfields comprises a reset period for initializing all the discharge cells, an address period for selecting cells to be discharged and a sustain period for representing gray level in accordance with the number of discharges.

The reset period comprises a setup period and a set-down period. During the setup period, a setup pulse is supplied to scan electrodes. The setup pulse generates a weak dark discharge in the discharge cells. This results in wall charges of a positive polarity being accumulated on address electrodes and sustain electrodes, and wall charges of a negative polarity being accumulated on the scan electrodes.

During the set-down period, a set-down pulse is supplied to the scan electrodes. This results in erasing a portion of the wall charges excessively accumulated on the scan electrodes such the remaining wall charges are uniform inside the discharge cells.

During the address period, a scan pulse is supplied to the scan electrodes, and a data pulse is supplied to the address electrodes. As the voltage difference between the scan pulse and the data pulse is added to the wall voltage produced during the reset period, the cells to be discharged are selected.

During the sustain period, a sustain pulse is supplied to the scan electrodes and the sustain electrodes. A sustain discharge occurs within the discharge cells selected during the address period, thereby displaying an image.

The driver of the plasma display apparatus supplies a driving pulse to the electrode of the plasma display panel during the reset period, the address period and the sustain period. In other words, the driver supplies the setup pulse and the set-down pulse during the reset period, the data pulse and the scan pulse during the address period, and the sustain pulse during the sustain period.

### SUMMARY OF THE INVENTION

In one aspect, a plasma display apparatus comprises a plasma display panel comprising an electrode, a voltage controller comprising a switch unit for forming a set-down pulse gradually falling to a first voltage for a first duration of time of a set-down period and for forming the first voltage for a second duration of time of an address period, a scan operating unit for forming a second voltage during the address period, and a driving signal supply unit for supplying the set-down pulse to the electrode during the set-down period, and for supplying the first voltage and the second voltage to the electrode during the address period.

In another aspect, a plasma display apparatus comprises a plasma display panel comprising an electrode, a voltage controller comprising a switch unit for forming a set-down pulse gradually falling to a first voltage for a first duration of time of a set-down period and for forming the first voltage for a second duration of time of an address period, a scan operating unit comprising a voltage source connected to one terminal of the switch unit for forming a second voltage during the address period, and a driving signal supply unit comprising a first switch unit for supplying the set-down pulse to the electrode during the set-down period and for supplying the first voltage and the second voltage to the electrode during the address period.

In still another aspect, a plasma display apparatus comprises a plasma display panel comprising an electrode, a voltage controller comprising a switch unit for forming a set-down pulse gradually falling to a first voltage for a first duration of time of a set-down period and for forming the first voltage for a second duration of time of an address period, a scan operating unit for forming a second voltage during the address period, a driving signal supply unit for supplying the set-down pulse to the electrode during the set-down period, and for supplying the first voltage and the second voltage to the electrode during the address period, and a controller for outputting a turn-on control signal to the switch unit.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates a plasma display apparatus according to an embodiment;

FIG. 2 illustrates a current path during a set-down period in the plasma display apparatus according to the embodiment;

FIG. 3 illustrates a current path during an address period in the plasma display apparatus according to the embodiment; and

FIG. 4 illustrates a waveform of a turn-on control signal for forming the current paths illustrated in FIGS. 2 and 3.

### DETAILED DESCRIPTION OF PREFERRED EMBODIMENTS

Preferred embodiments of the present invention will be described in a more detailed manner with reference to the drawings.

A plasma display apparatus comprises a plasma display panel comprising an electrode, a voltage controller comprising a switch unit for forming a set-down pulse gradually falling to a first voltage for a first duration of time of a set-down period and for forming the first voltage for a second duration of time of an address period, a scan operating unit for forming a second voltage during the address period, and a driving signal supply unit for supplying the set-down pulse to the electrode during the set-down period, and for supplying the first voltage and the second voltage to the electrode during the address period.

The switch unit may be turned on for the first duration of time and the second duration of time.

The switch unit may operate in an active region for the first duration of time, and may operate in a saturation region for the second duration of time.

The driving signal supply unit may supply a scan pulse maintained at the first voltage to the electrode.

The plasma display apparatus may further comprise a setup controller for forming a setup pulse rising from a sustain voltage to two times the sustain voltage during a setup period.

A plasma display apparatus comprises a plasma display panel comprising an electrode, a voltage controller comprising a switch unit for forming a set-down pulse gradually falling to a first voltage for a first duration of time of a set-down period and for forming the first voltage for a second duration of time of an address period, a scan operating unit comprising a voltage source connected to one terminal of the switch unit for forming a second voltage during the address period, and a driving signal supply unit comprising a first switch unit for supplying the set-down pulse to the electrode during the set-down period and for supplying the first voltage and the second voltage to the electrode during the address period.

The switch unit of the voltage controller may be turned on for the first duration of time and the second duration of time.

The scan operating unit may comprise a switch unit which operates in an active region for the first duration of time and operates in a saturation region for the second duration of time.

The driving signal supply unit may further comprise a second switch unit for supplying a scan pulse maintained at the first voltage to the electrode. One terminal of the second switch unit may be connected to one terminal of the switch unit of the voltage controller.

When the second switch unit supplies the scan pulse, the switch unit of the voltage controller may operate in a saturation region.

The plasma display apparatus may further comprises a setup controller for forming a setup pulse rising from a sustain voltage to two times the sustain voltage during a setup period.

A plasma display apparatus comprises a plasma display panel comprising an electrode, a voltage controller comprising a switch unit for forming a set-down pulse gradually falling to a first voltage for a first duration of time of a set-down period and for forming the first voltage for a second duration of time of an address period, a scan operating unit for forming a second voltage during the address period, a driving signal supply unit for supplying the set-down pulse to the electrode during the set-down period, and for supplying the first voltage and the second voltage to the electrode during the address period, and a controller for outputting a turn-on control signal to the switch unit.

The switch unit may operate in an active region for the first duration of time, and may operate in a saturation region for the second duration of time.

The driving signal supply unit may supply a scan pulse maintained at the first voltage to the electrode.

The plasma display apparatus may further comprise a setup controller for forming a setup pulse rising from a sustain voltage to two times the sustain voltage during a setup period.

Hereinafter, exemplary embodiments of the present invention will be described in detail with reference to the attached drawings.

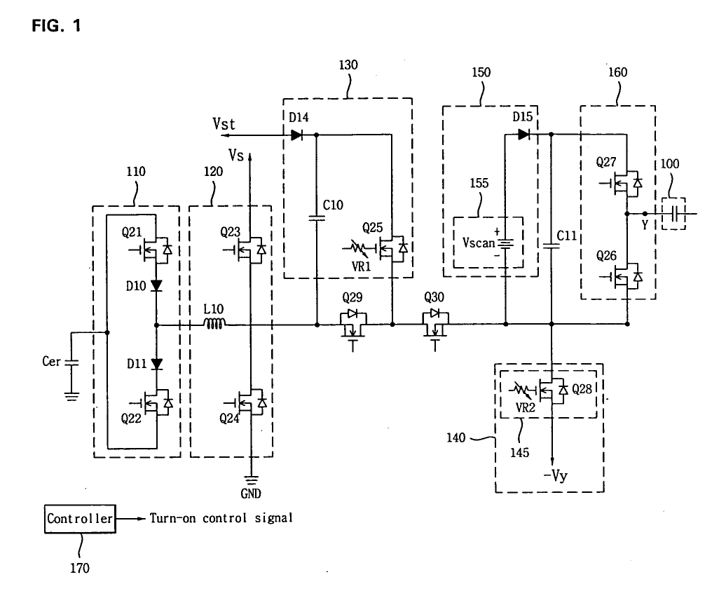

FIG. 1 illustrates a plasma display apparatus according to an embodiment. As illustrated in FIG. 1, the plasma display apparatus according to the embodiment comprises a plasma display panel 100, an energy supply/recovery controller 110, a sustain controller 120, a setup controller 130, a voltage controller 140, a scan operating unit 150, a driving signal supply unit 160 and a controller 170.

The energy supply/recovery controller 110 supplies energy stored in a capacitor Cer to a scan electrode Y of the plasma display panel 100, or recovers energy from the scan electrode Y to the capacitor Cer. The energy supply/recovery controller 110 comprises an energy supply switch Q21 and an energy recovery switch Q22 which are connected to one terminal of the capacitor Cer. The energy supply switch Q21 is connected to an anode of a diode D10 for causing a current to flow from the capacitor Cer to the scan electrode Y of the plasma display panel 100. The energy recovery switch Q22 is connected to a cathode of a diode D11 for causing a current to flow from the scan electrode Y of the plasma display panel 100 to the capacitor Cer.

The sustain controller 120 supplies a sustain voltage Vs or a ground level voltage GND to the scan electrode Y of the plasma display panel 100, thereby generating a sustain discharge during a sustain period. The sustain controller 120 comprises a sustain up switch Q23 for supplying the sustain voltage Vs to the scan electrode Y, and a sustain down switch Q24 for supplying the ground level voltage GND to the scan electrode Y. The sustain controller 120 further comprises an inductor L10 for forming resonance when supplying or recovering the energy to or from the scan electrode Y.

The setup controller 130 forms a setup pulse rising from the sustain voltage Vs to a setup voltage Vst during a setup period of a reset period. The setup controller 130 comprises a capacitor C10 charged to the setup voltage Vst in an initial state. When the sustain up switch Q23 of the sustain controller 120, a switch Q29 and a switch Q30 are turned on, the sustain voltage Vs is supplied to the capacitor C10 and the scan electrode Y, and a voltage of one terminal of the capacitor C10 connected to a cathode of a diode D14 of the setup controller 130 rises to a sum (Vs+Vst) of the sustain voltage Vs and the setup voltage Vst. Further, when a switch Q25 of the setup controller 130 operates in its active region, the setup pulse gradually rising from the sustain voltage Vs to the sum (Vs+Vst) of the sustain voltage Vs and the setup voltage Vst is formed. A first variable resistance VR1 connected to a gate terminal of the switch Q25 controls a channel width of the setup pulse. A magnitude of the setup voltage Vst may be substantially equal to a magnitude of the sustain voltage Vs such that the highest voltage of the setup pulse may be equal to two times the sustain voltage Vs. When the magnitude of the setup voltage Vst is substantially equal to the magnitude of the sustain voltage Vs, the configuration of a circuit of the plasma display apparatus is simple and the manufacturing cost of the plasma display apparatus decreases.

The voltage controller 140 comprises a switch unit 145 for forming a set-down pulse gradually falling from the sustain voltage Vs to a first voltage −Vy for a first duration of time of a set-down period and for forming the first voltage −Vy for a second duration of time of an address period. The first duration of time indicates a duration of time when a switch Q28 of the switch unit 145 operates in its active region. The second duration of time indicates a duration of time when the switch Q28 of the switch unit 145 operates in its saturation region. In other words, when the switch Q28 of the voltage controller 140 remains constantly in a turn-on state for the first duration of time and the second duration of time, the switch Q28 forms the set-down pulse for the first duration of time and forms the first voltage −Vy for the second duration of time. The voltage controller 140 comprises a second variable resistance VR2 connected to a gate terminal of the switch Q28. A channel width of the set-down pulse depends on a magnitude of a resistance of the second variable resistance VR2. In other words, since the voltage controller 140 of the plasma display apparatus according to the embodiment forms the set-down pulse and the first voltage −Vy through one switch (i.e., the switch Q28), the configuration of the circuit of the plasma display apparatus is simple and the manufacturing cost of the plasma display apparatus decreases.

The scan operating unit 150 forms a second voltage Vscan during the address period. When the switch unit 145 of the voltage controller 140 operates in the saturation region in a state charging a capacitor C11 of the scan operating unit 150 to the second voltage Vscan, the first voltage −Vy is supplied through one terminal of the capacitor C11 such that a voltage of the other terminal of the capacitor C11 is equal to a sum (−Vy+Vscan) of the first voltage −Vy and the second voltage Vscan. The sum (−Vy+Vscan) of the first voltage −Vy and the second voltage Vscan is a scan bias voltage supplied to the scan electrode Y when a scan pulse is not supplied during the address period. A diode D15 of the scan operating unit 150 prevents an inverse current flowing to a voltage source 155 for supplying the second voltage Vscan.

The driving signal supply unit 160 supplies the set-down pulse to the scan electrode Y during the set-down period, and supplies the first voltage −Vy and the second voltage Vscan to the scan electrode Y during the address period. The driving signal supply unit 160 comprises two switches Q26 and Q27. When the switch Q26 of the driving signal supply unit 160 is turned on, the switch Q27 is turned off. When the switch unit 145 of the voltage controller 140 operates in the active region for the first duration of time, the switch Q26 supplies the set-down pulse formed by the switch unit 145 to the scan electrode Y during the set-down period. Further, when the switch unit 145 of the voltage controller 140 operates in the saturation region for the second duration of time, the switch Q26 supplies the first voltage −Vy formed by the switch unit 145 to the scan electrode Y during the address period. The first voltage −Vy is equal to the lowest voltage of the scan pulse supplied to the scan electrode Y. The switch Q27 supplies the scan bias voltage (−Vy+Vscan) to the scan electrode Y.

The controller 170 outputs a turn-on control signal for controlling a turn-on operation or a turn-off operation of the switches of the plasma display apparatus illustrated in FIG. 1.

The following is a detailed description of an operation of the plasma display apparatus according to the embodiment.

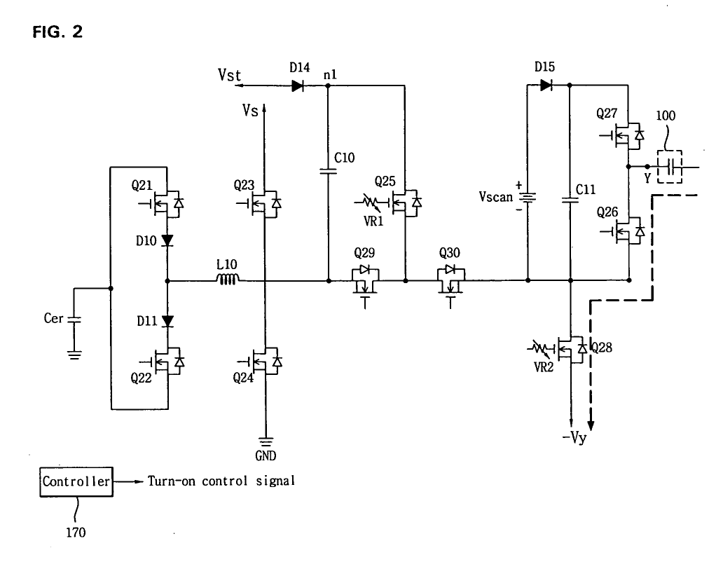

FIG. 2 illustrates a current path during a set-down period in the plasma display apparatus according to the embodiment.

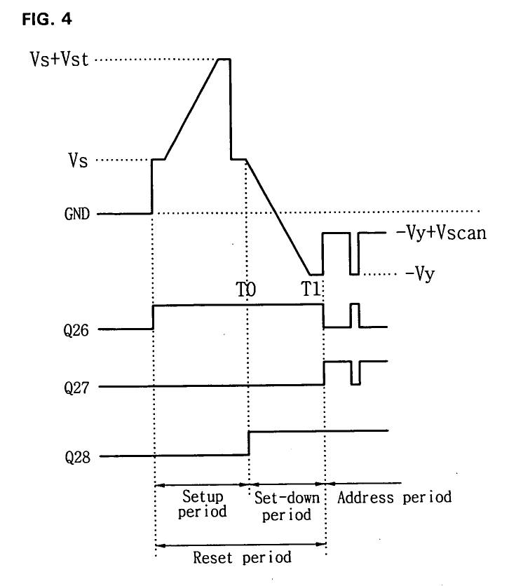

During the setup period of FIG. 4, the switches Q23, Q29, Q30 and Q26 are turned on. As a result, the sustain voltage Vs is supplied to the scan electrode Y. Further, a voltage of one terminal n1 of the capacitor C10 charged to the setup voltage Vst rises to a sum of the sustain voltage Vs and the setup voltage Vst.

When the switch Q25 is turned on in its active region, the setup pulse gradually rising from the sustain voltage Vs to the sum (Vs+Vst) of the sustain voltage Vs and the setup voltage Vst is supplied to the scan electrode Y.

During the set-down period of FIG. 4, the switch Q30 is turned off, the switch Q28 is turned on for the first duration of time (T1−T0), and the switch Q26 remains in a turn-on state. Since the switch Q28 operates in its active region, the set-down pulse falling from the sustain voltage Vs to the first voltage −Vy is supplied to the scan electrode Y. Accordingly, a current path passing through the scan electrode Y, the switch Q26 and the switch Q28 is formed.

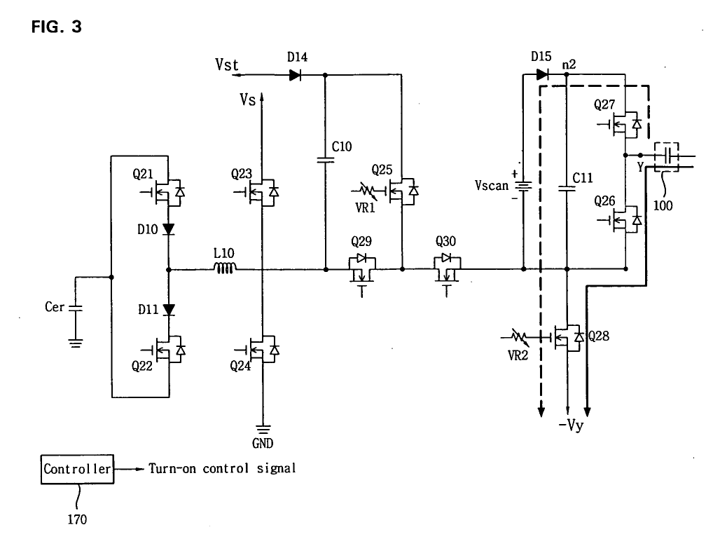

FIG. 3 illustrates a current path during an address period in the plasma display apparatus according to the embodiment.

During the address period of FIG. 4, the switch Q28 remains in a turn-on state, the switch Q26 is turned off, and the switch Q27 is turned on. As a result, since the switch Q28 operates in its saturation region for the second duration of time, the switch Q28 supplies the first voltage −Vy to the scan electrode Y. When the switch Q28 supplies the first voltage −Vy, the voltage of the other terminal n2 of the capacitor C11 is equal to the sum (−Vy+Vscan) of the first voltage −Vy and the second voltage Vscan, and the sum (−Vy+Vscan) of the first voltage −Vy and the second voltage Vscan is supplied to the scan electrode Y through the switch Q27. The sum (−Vy+Vscan) of the first voltage −Vy and the second voltage Vscan is substantially equal to the scan bias voltage. Accordingly, as illustrated in FIG. 3, a current path (indicated by a dotted line) passing through the switch Q27, the capacitor C11 and the switch Q28 is formed.

During the address period of FIG. 4, the switch Q28 remains in a turn-on state, the switch Q26 is turned on, and the switch Q27 is turned off. As a result, since the switch Q28 operates in its saturation region for the second duration of time, the switch Q28 constantly supplies the first voltage −Vy to the scan electrode Y. When the switch Q28 constantly supplies the first voltage −Vy and the switch Q26 is turned on, the first voltage −Vy is supplied to the scan electrode Y. In other words, the scan pulse having the lowest voltage substantially equal to the first voltage −Vy is supplied to the scan electrode Y. Accordingly, a current path (indicated by a bold solid line) passing through the scan electrode Y, the switch Q26 and the switch Q28 is formed.

As described through FIGS. 2 to 4, since the plasma display apparatus forms the set-down pulse, the scan bias voltage and the scan pulse through one switch Q28, the configuration of the circuit of the plasma display apparatus is simple and the manufacturing cost of the plasma display apparatus decreases.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising an electrode;
a voltage controller comprising a switch unit for forming a set-down pulse gradually falling to a first voltage for a first duration of time of a set-down period and for forming the first voltage for a second duration of time of an address period;
a scan operating unit for forming a second voltage during the address period; and
a driving signal supply unit for supplying the set-down pulse to the electrode during the set-down period, and for supplying the first voltage and the second voltage to the electrode during the address period.

2. The plasma display apparatus of claim 1, wherein the switch unit is turned on for the first duration of time and the second duration of time.

3. The plasma display apparatus of claim 1, wherein the switch unit operates in an active region for the first duration of time, and operates in a saturation region for the second duration of time.

4. The plasma display apparatus of claim 1, wherein the driving signal supply unit supplies a scan pulse maintained at the first voltage to the electrode.

5. The plasma display apparatus of claim 1, further comprising a setup controller for forming a setup pulse rising from a sustain voltage to two times the sustain voltage during a setup period.

6. A plasma display apparatus comprising:
a plasma display panel comprising an electrode;
a voltage controller comprising a switch unit for forming a set-down pulse gradually falling to a first voltage for a first duration of time of a set-down period and for forming the first voltage for a second duration of time of an address period;
a scan operating unit comprising a voltage source connected to one terminal of the switch unit for forming a second voltage during the address period; and
a driving signal supply unit comprising a first switch unit for supplying the set-down pulse to the electrode during the set-down period and for supplying the first voltage and the second voltage to the electrode during the address period.

7. The plasma display apparatus of claim 6, wherein the switch unit of the voltage controller is turned on for the first duration of time and the second duration of time.

8. The plasma display apparatus of claim 6, wherein the scan operating unit comprises a switch unit which operates in an active region for the first duration of time and operates in a saturation region for the second duration of time.

9. The plasma display apparatus of claim 6, wherein the driving signal supply unit further comprises a second switch unit for supplying a scan pulse maintained at the first voltage to the electrode, and
one terminal of the second switch unit is connected to one terminal of the switch unit of the voltage controller.

10. The plasma display apparatus of claim 9, wherein when the second switch unit supplies the scan pulse, the switch unit of the voltage controller operates in a saturation region.

11. The plasma display apparatus of claim 6, further comprising a setup controller for forming a setup pulse rising from a sustain voltage to two times the sustain voltage during a setup period.

12. A plasma display apparatus comprising:
a plasma display panel comprising an electrode;
a voltage controller comprising a switch unit for forming a set-down pulse gradually falling to a first voltage for a first duration of time of a set-down period and for forming the first voltage for a second duration of time of an address period;
a scan operating unit for forming a second voltage during the address period;
a driving signal supply unit for supplying the set-down pulse to the electrode during the set-down period, and for supplying the first voltage and the second voltage to the electrode during the address period; and
a controller for outputting a turn-on control signal to the switch unit.

13. The plasma display apparatus of claim 12, wherein the switch unit operates in an active region for the first duration of time, and operates in a saturation region for the second duration of time.

14. The plasma display apparatus of claim 12, wherein the driving signal supply unit supplies a scan pulse maintained at the first voltage to the electrode.

15. The plasma display apparatus of claim 12, further comprising a setup controller for forming a setup pulse rising from a sustain voltage to two times the sustain voltage during a setup period.
